(19) United States
(12) Patent Application Publication
(10) Pub. No.: US 2026/0211165 A1
(43) Pub. Date: Jul. 23, 2026

(54) ELECTRONIC DEVICE AND METHOD FOR MANUFACTURING SAME

(71) Applicant: LG ELECTRONICS INC., Seoul (KR)

(72) Inventors: Heechul JUNG, Seoul (KR); Junhyung LEE, Seoul (KR); Younseob KIM, Seoul (KR); Junewoo SEO, Seoul (KR); Dongkyun KANG, Seoul (KR); Minju KIM, Seoul (KR)

(73) Assignee: LG ELECTRONICS INC., Seoul (KR)

(21) Appl. No.: 19/328,412

(22) Filed: Sep. 15, 2025

(30) Foreign Application Priority Data
Jan. 23, 2025 (WO) PCT/KR2025/001381

(51) Int. Cl. G02B 5/26

(52) U.S. Cl. CPC G02B 5/26

(57) ABSTRACT

The present disclosure is applicable to a technical field related to the exterior of various devices, and relates to, for example, an electronic device and a method for manufacturing the same. In an aspect of the present disclosure, an electronic device may include a base layer; a color layer comprising a first layer disposed on the base layer and having a first color; a first resin layer disposed on the color layer and having a first pattern; a second resin layer disposed on the first resin layer and having a second pattern; and a gloss layer disposed between the first resin layer and the second resin layer, which imparts gloss to the color layer.

### BACKGROUND

### 1. Technical Field

The present disclosure is applicable to a technical field related to the exterior of various devices, and relates to, for example, an electronic device and a method for manufacturing the same.

### 2. Description of Related Art

The surfaces of electronic devices, such as laptop computers, are typically made of stainless steel (SUS). To prevent surface corrosion and fingerprints, the surface can be processed to form various patterns.

The Patterns can be formed on stainless steel using brushes or sandpaper. Furthermore, this process for forming patterns on stainless steel can be applied to materials such as aluminum. When using aluminum, this process requires post-processing, such as anodizing. However, this post-processing process can result in reduced pattern visibility or blurring of product logos or branding. Specifically, the process of applying post-processing can reduce the visibility of the pattern formed on the metal substrate surface, and differences in shape may occur from the original pattern.

Conventionally, spraying is the most common method for applying color to the exterior of electronic devices, but this method has the disadvantage of producing a monotonous appearance. To achieve a metallic feel, laptop computers may use aluminum, but in this case, the conventional anodizing process may not produce a pure white color.

### SUMMARY

The present disclosure provides an electronic device capable of producing a consistent quality by applying a pattern to multiple electronic devices, and a manufacturing method thereof.

The present disclosure provides an electronic device capable of implementing various colors, including white, and a manufacturing method thereof.

The present disclosure provides an electronic device capable of imparting aesthetics and functionality through patterns in addition to color expression, and a manufacturing method thereof.

The present disclosure provides an electronic device capable of implementing a metallic gloss, and a manufacturing method thereof.

The present disclosure provides an electronic device capable of expressing a three-dimensional feel by applying a pattern, and a manufacturing method thereof.

Furthermore, those skilled in the art will understand, upon reading the entire specification and drawings, that other embodiments of the present disclosure may present additional technical challenges not mentioned herein.

In an aspect of the present disclosure, an electronic device may include a base layer; a color layer comprising a first layer disposed on the base layer and having a first color; a first resin layer disposed on the color layer and having a first pattern; a second resin layer disposed on the first resin layer and having a second pattern; and a gloss layer disposed between the first resin layer and the second resin layer, which imparts gloss to the color layer.

In another aspect of the present disclosure, a method for manufacturing an electronic device may include surface-treating a base layer; forming a color layer on the base layer; forming a first resin layer on the color layer; adhering a first pattern mold having a first pattern on the first resin layer; curing the first resin layer; and removing the first pattern mold to expose the first pattern.

In still another aspect of the present disclosure, a method for manufacturing an electronic device may include surface-treating a base layer; forming a colored resin layer on the base layer, to which a color is provided to a resin layer; bonding a first pattern mold having a first pattern on the colored resin layer; curing the colored resin layer; and removing the first pattern mold to expose the first pattern.

### BRIEF DESCRIPTION OF THE DRAWINGS

FIG. 1 is a perspective view illustrating an electronic device according to the embodiments of the present disclosure.

FIG. 2 is a cross-sectional view illustrating a top plate of an electronic device according to a first embodiment of the present disclosure.

FIG. 3 is a cross-sectional view illustrating a top plate of an electronic device according to a modified example of the first embodiment of the present disclosure.

FIG. 4 is a cross-sectional view illustrating a top plate of an electronic device according to a second embodiment of the present disclosure.

FIGS. 5 to 10 are cross-sectional views illustrating a process of manufacturing an electronic device according to a first embodiment of the present disclosure.

FIGS. 11 and 12 are cross-sectional views illustrating a process for manufacturing an electronic device according to a second embodiment of the present disclosure.

FIG. 13 is a flowchart illustrating a process for manufacturing an electronic device according to a first embodiment of the present disclosure.

FIG. 14 is a flowchart illustrating a process for manufacturing an electronic device according to a second embodiment of the present disclosure.

FIG. 15 is a cross-sectional view illustrating a top plate of an electronic device according to a third embodiment of the present disclosure.

FIG. 16 is a cross-sectional view illustrating a top plate of an electronic device according to a fourth embodiment of the present disclosure.

### DETAILED DESCRIPTION OF THE EMBODIMENTS

Hereinafter, the embodiments related to the present disclosure will be described in more detail with reference to the drawings. The suffixes “module” and “part” used in the following description for components are assigned or used interchangeably solely for the convenience of writing the specification, and do not inherently have distinct meanings or roles.

The electronic device according to embodiments of the present disclosure may be, for example, a computer, a laptop computer, a tablet, and the like, and may also be applied to a smartphone in some cases. Furthermore, the plate-shaped substrate applied to the electronic device according to embodiments of the present disclosure may also be applied to interior and exterior materials of an automobile, ab aircraft, a ship, and the like.

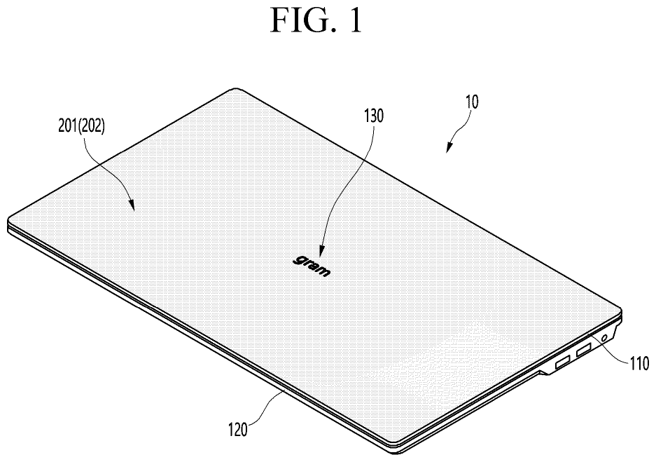

FIG. 1 is a perspective view illustrating an electronic device according to the embodiments of the present disclosure.

Referring to FIG. 1, a perspective view of an electronic device 10 according to the embodiments of the present disclosure is illustrated. Here, a laptop computer is illustrated as a specific example of the electronic device 10.

For example, the embodiments of the present disclosure may be applied to the electronic device 10 such as a laptop computer. However, the embodiments of the present disclosure are not limited thereto and may be used for interior and exterior materials of various electronic devices, such as a smartphone, a tablet, a TV, and a desktop computer. The embodiments of the present disclosure may also be applied to various interior and exterior materials of an automobile, a ship, and the like. Furthermore, the embodiments of the present disclosure may be used for interior and exterior materials of buildings as well as general furniture.

Hereinafter, a laptop computer will be described as a specific example of the electronic device 10. Hereinafter, the electronic device 10 and the laptop computer 10 will be described using the same reference numeral.

The electronic device 10, such as a laptop computer, may typically include a top plate 110 and a bottom plate 120. Among these, the top plate 110 may include functional layers for color, pattern, and gloss to enhance aesthetic appeal, durability, and tactile qualities. In addition, the top plate 110 may be marked with letters or patterns such as a brand, manufacturer, or logo of the electronic device 10.

Referring to FIG. 1, an example in which a brand 130 is marked on the top plate 110 of the electronic device 10 is shown. In addition, an example in which patterns 201 and 202 are provided on the surface of the top plate 110 of the electronic device 10 is shown. For example, these patterns 201 and 202 may function to improve the appearance. For example, these patterns 201 and 202 may improve the touch feeling, grip feeling, and grip feeling, and the like. by preventing slipperiness when a user touches the top plate 110. For example, these patterns 201 and 202 may prevent damage such as corrosion of the top plate 110. For example, these patterns 201 and 202 may prevent contamination such as fingerprint marks of a user.

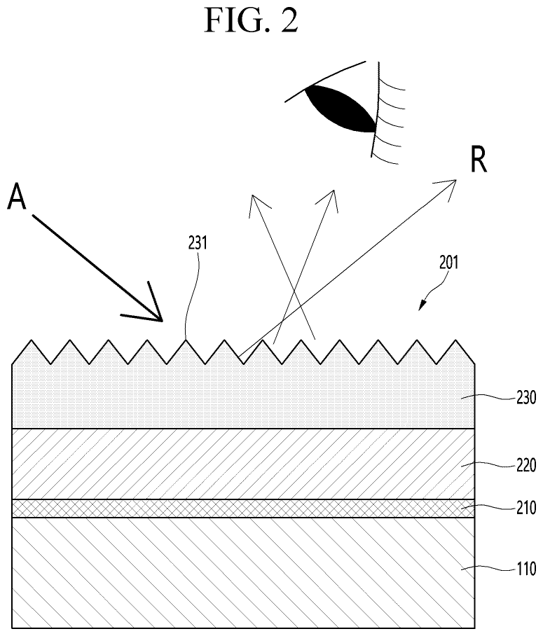

FIG. 2 is a cross-sectional view illustrating a top plate of an electronic device according to a first embodiment of the present disclosure.

Referring to FIG. 2, a state in which functional layers 210, 220, and 230 are provided on the top plate 110 of the electronic device 10 according to a first embodiment of the present disclosure is schematically illustrated.

Here, the first embodiment of the present disclosure exemplarily illustrates a state in which functional layers 210, 220, and 230 are provided on the top plate 110 of the electronic device 10. Therefore, the top plate 110 of the electronic device 10 may be referred to as a base layer. That is, the functional layers 210, 220, and 230 may be implemented by being combined with the base layers of various products. For example, the base layer including these functional layers 210, 220, and 230 may be referred to as a plate-shaped substrate.

Hereinafter, the top plate 110 and the base layer 110 will be described using the same reference numeral.

For example, the base layer 110 may include a metal substrate. For example, the base layer 110 may include aluminum (Al) or magnesium (Mg). For example, the base layer 110 may be formed of aluminum (Al) or magnesium (Mg).

Referring to FIG. 2, a color layer 220 may be disposed on the top plate 110 (base layer). For example, a chemical treatment may be performed to prevent corrosion and/or improve adhesion of the base layer 110. Accordingly, a chemical layer or primer 210 formed as a result of chemical treatment may be provided between the base layer 110 and the color layer 220.

The color layer 220 including a first layer having a first color may be disposed on the chemical layer or primer 210. For example, the color layer 220 may be formed as a first layer having a first color.

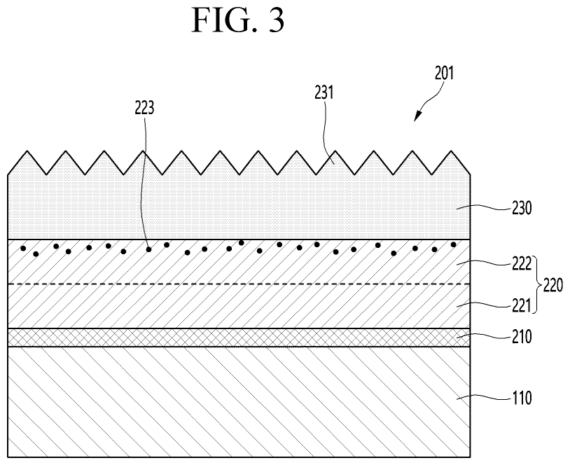

The color layer 220 may impart a color to the base layer 110. For example, white, gray, black, or other colors may be imparted to the base layer 110. For example, two or more color layers 220 may be provided to express the color intensity. Meanwhile, the color layer 220 may also include particles 223 for expressing color. This will be described later with reference to FIG. 3.

When a character or a pattern 130 (see FIG. 1) such as a brand, manufacturer, or logo of the electronic device 10 is displayed, the character or pattern 130 may be displayed using the color layer 220.

A resin layer 230 may be disposed on the color layer 220. A pattern 201 having unit shapes 231 may be provided on the surface of the resin layer 230. The pattern 201 may include at least one of a random pattern, a hairline pattern, an etched pattern, an embossed pattern, a sandblasted pattern, a mirror pattern, or an optical pattern.

By the pattern 201 as described above, a reflected light R by an incident light A is diffusely reflected at various angles, so that the resin layer 230 may improve the appearance together with the color layer 220. Meanwhile, as described above, the resin layer 230 having the pattern 201 may improve the appearance of the electronic device 10 including the base layer 110. For example, the resin layer 230 having the pattern 201 may improve the sensory qualities such as the touch, grip, and gripping sensation. For example, the resin layer 230 having the pattern 201 may prevent damage such as corrosion of the top plate 110 and contamination such as fingerprint marks of the user.

For example, the surface of the electronic device such as a laptop computer may be made of stainless steel (SUS). In this case, the surface may be processed to form various patterns in order to prevent corrosion and fingerprint marks of the surface.

To form a pattern on such stainless steel, a brush or sandpaper may be used. Furthermore, the process of forming a pattern on such stainless steel may be applied to materials such as aluminum. When using aluminum, the process requires post-processing, such as anodizing. However, the post-processing process may cause problems such as reduced pattern visibility or blurring of product logos or branding. Specifically, the process of applying post-processing may reduce the visibility of the pattern formed on the surface of the metal base layer, and differences in shape from the initially formed pattern may occur.

However, according to the embodiments of the present disclosure, the desired pattern shape may be expressed without change, and this pattern may be applied to multiple electronic devices to produce them with consistent quality. Thus, the embodiments of the present disclosure may improve the reproducibility and stability of pattern formation, as well as productivity.

FIG. 3 is a cross-sectional view illustrating a top plate of an electronic device according to a modified example of the first embodiment of the present disclosure.

As mentioned above, referring to FIG. 3, the color layer 220 may be provided with two or more layers to express the depth of color. For example, the color layer 220 may include a first layer 221 having a first color and a second layer 222 disposed on the first layer 221 and having a second color. However, the present disclosure is not limited thereto. For example, a sufficient color depth may be expressed with the color layer 220 including the single layer 221.

For example, a deeper color depth may be expressed by using the color layer 220 including the first layer 221 having the first color and the second layer 222 having the second color. For example, the first color and the second color may be the same. For example, the first color and the second color may be colors of the same series. For example, the first and second colors may be grayscales with different brightnesses. As an exemplary embodiment, the first and second colors may be the same white. In this way, a deeper color may be expressed by using two layers 221 and 222 or more layers.

Meanwhile, the color layer 220 may include particles 223 for color expression. The particles 223 may impart additional color or gloss to the color layer 220. For example, the particles 223 may impart a pearl color or metallic gloss. For example, the particles 223 may include metal particles or metal oxide particles.

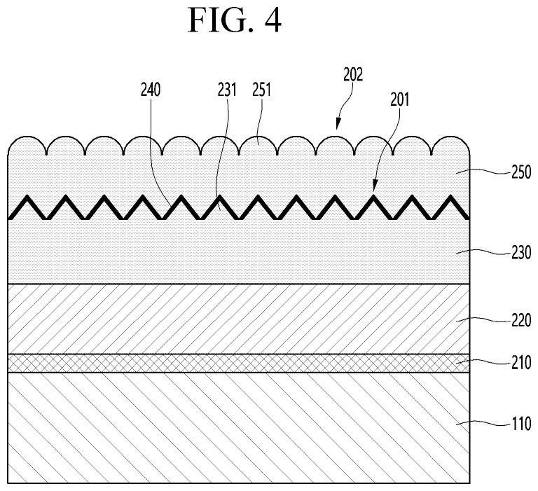

FIG. 4 is a cross-sectional view illustrating a top plate of an electronic device according to a second embodiment of the present disclosure.

Referring to FIG. 4, a state in which functional layers 210, 220, 230, 240, and 250 are provided on the top plate 110 of the electronic device 10 according to a second embodiment of the present disclosure is schematically illustrated.

Here, the second embodiment of the present disclosure illustrates a state in which the functional layers 210, 220, 230, 240, and 250 are provided on the top plate 110 of the electronic device 100 is exemplarily shown. Therefore, the top plate 110 of the electronic device 10 may be referred to as the base layer. That is, the functional layers 210, 220, 230, 240, and 250 may be implemented by being combined with the base layers of various products. For example, the base layer including these functional layers 210, 220, and 230 may be referred to as a plate-shaped substrate. Hereinafter, the top plate 110 and the base layer 110 will be described using the same drawing reference numeral.

For example, the base layer 110 may include a metal substrate. For example, the base layer 110 may include aluminum (Al) or magnesium (Mg). For example, the base layer 110 may be formed of aluminum (Al) or magnesium (Mg).

Referring to FIG. 4, the color layer 220 may be disposed on the top plate 110 (base layer). For example, a chemical treatment may be performed to prevent corrosion and/or improve adhesion of the base layer 110. Accordingly, the chemical layer or primer 210 formed as a result of the chemical treatment may be provided between the base layer 110 and the color layer 220.

The color layer 220 including the first layer having the first color may be disposed on the chemical layer or primer 210. For example, the color layer 220 may be formed as the first layer having the first color.

The color layer 220 may impart color to the base layer 110. For example, white, gray, black, or other colors may be applied to the base layer 110. For example, two or more color layers 220 may be provided to express the color intensity (see FIG. 3). Meanwhile, the color layer 220 may also include the particles 223 for color expression (see FIG. 3).

When the character or pattern 130 (see FIG. 1), such as the brand, manufacturer, or logo of the electronic device 10, are displayed, the character or pattern 130 may be displayed using the color layer 220.

The resin layer 230 (hereinafter, referred to as the first resin layer) may be disposed on the color layer 220. The pattern 201 (hereinafter, referred to as the first pattern) having unit shapes 231 may be provided on the surface of the first resin layer 230. The first pattern 201 may include at least one of a diffuse pattern, a hairline pattern, an etched pattern, an embossed pattern, a sandblasted pattern, a mirror pattern, or an optical pattern.

By the first pattern 201, the reflected light R from the incident light A is diffusely reflected at various angles, so that the first resin layer 230 may improve the appearance together with the color layer 220. Meanwhile, as described above, the first resin layer 230 having the pattern 201 may improve the appearance of the electronic device 10 including the base layer 110.

A gloss layer 240 that imparts gloss to the color layer 220 may be disposed on this first resin layer 230. For example, the gloss layer 240 may impart a metallic gloss.

For example, the gloss layer 240 may include either chromium (Cr) or zirconium (Zr). However, the present disclosure is not limited thereto. For example, the gloss layer 240 may be formed on the first resin layer 230 using a PVD (Physical Vapor Deposition) method.

For example, when the character or pattern 130 (see FIG. 1) such as a brand, manufacturer, or logo of the electronic device 10 is displayed, the character or pattern 130 may be displayed using the gloss layer 240. For example, the character or pattern 130 may be formed using a PVD (Physical Vapor Deposition) method.

A second resin layer 250 may be disposed on the gloss layer 240. The pattern 202 (hereinafter, referred to as a second pattern) having unit shapes 251 may be provided on the surface of the second resin layer 240. The second pattern 202 may include at least one of a random pattern, a hairline pattern, an etched pattern, an embossed pattern, a sandblasted pattern, a mirror pattern, or an optical pattern. The second pattern 202 and the first pattern 201 may be the same or different from each other.

For example, the second resin layer 250 having the second pattern 202 may be exposed to the outside to improve sensory qualities such as touch, grip, and gripping sensation. For example, the second resin layer 250 having the pattern 202 may prevent damage such as corrosion of the top plate 110 and contamination such as fingerprint marks of the user.

In this way, the gloss layer 240 that imparts gloss to the color layer 220 may be provided between the first resin layer 230 and the second resin layer 250.

As mentioned above, at least one of the first pattern 201 and the second pattern 202 may include at least one of a random pattern, a hairline pattern, an etched pattern, an embossed pattern, a sandblasted pattern, a mirror pattern, or an optical pattern.

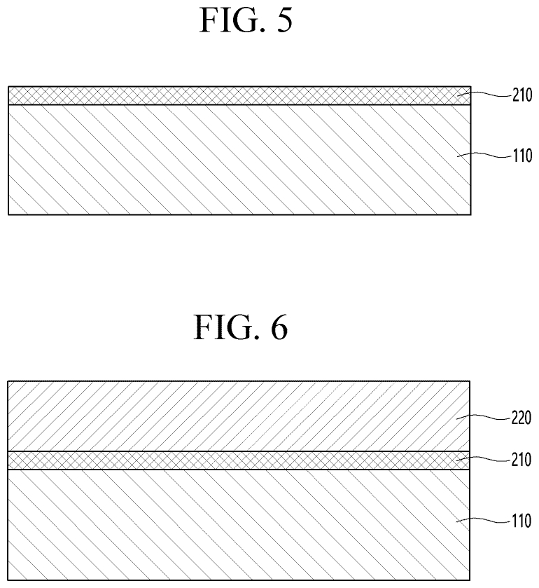

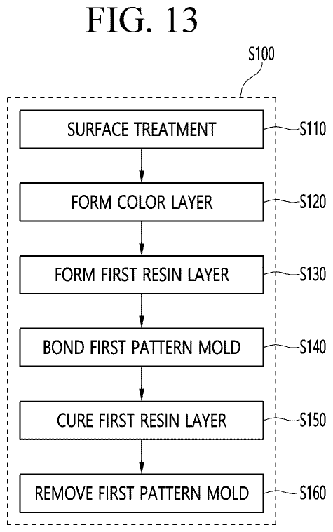

FIGS. 5 to 10 are cross-sectional views illustrating a process of manufacturing an electronic device according to a first embodiment of the present disclosure. FIG. 13 is a flowchart illustrating a process for manufacturing an electronic device according to a first embodiment of the present disclosure.

Hereinafter, a process S100 for manufacturing the electronic device according to a first embodiment of the present disclosure will be described step-by-step with reference to FIGS. 5 to 10 and FIG. 13.

First, referring to FIG. 5, the base layer 110 of the electronic device 10 may be surface-treated (step S110). For example, the base layer 110 of the electronic device 10 may be chemically treated or the primer 210 may be applied.

Accordingly, the chemical layer or primer 210 may be formed on the base layer 110 as a result of the chemically treated layer. This chemical layer or primer 210 may improve the adhesion of a functional layer, for example, the color layer 220, formed later.

Referring to FIG. 6, the color layer 220 may be formed on the base layer 110 (step S120). The color layer 220 may be assigned white, gray, black, or other colors. There is no limitation on the colors assigned to the color layer 220, allowing the formation of a variety of color layers 220.

In particular, the color layer 220 may be white. While it is usually difficult to achieve a white color through post-processing of metal (e.g., anodizing), the embodiments of the present disclosure allow the implementation of the color layer 220 having a clear white color.

The step of forming the color layer 220 may be performed by performing silk printing on the base layer 110.

When the character or pattern 130 (see FIG. 1) such as a brand, manufacturer, or logo of an electronic device 10 is displayed, the character or pattern 130 may be displayed using the color layer 220. For example, after the first layer 221 having the first color is printed on the base layer 110, the character or pattern 130 such as a brand, manufacturer, or logo may be printed on the first layer 221.

Meanwhile, for example, the color layer 220 may be provided in two or more layers to express the density of color. For example, the step of forming the color layer 220 may include a step of forming the first layer 221 (see FIG. 3) having the first color and a step of forming the second layer 222 (see FIG. 3) having the second color on the first layer. In some cases, the second layer 222 having the second color may include the character or pattern 130, such as the brand, manufacturer, or logo described above.

In an exemplary embodiment, the color layer 220 may include the particles 223 (see FIG. 3) for expressing color. For example, after applying the color layer 220, the particles 223 for expressing color may be applied, or silk printing may be performed using a material containing the particles 223. The particles 223 may include metal or metal oxide particles. For example, the process of forming the color layer 220 may include a process of applying metal or metal oxide particles.

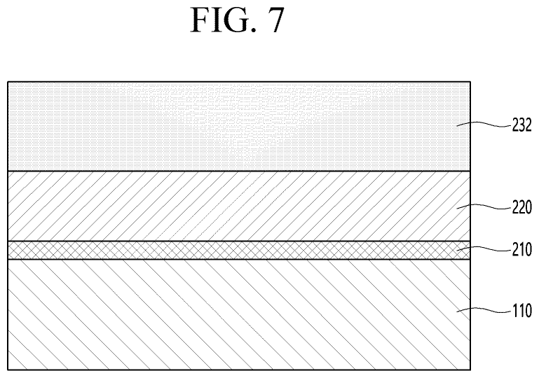

Next, referring to FIG. 7, a first resin layer 232 may be formed on the color layer 220 (step S130). The first resin layer 232 may be a flexible resin layer prior to curing. Meanwhile, in addition to resin, various materials that may be cured through post-processing may be used. For example, various materials that may be cured by heat or light ultraviolet rays in addition to resin may be used.

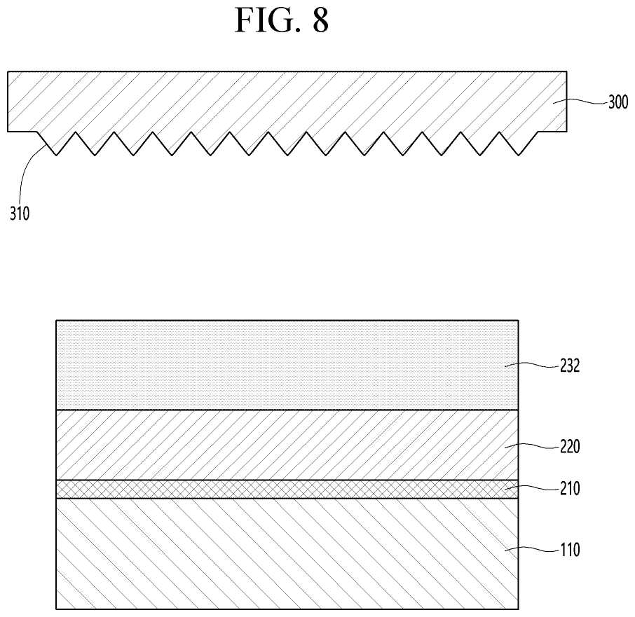

Referring to FIG. 8, a first pattern mold 300 having the first pattern 201 or the corresponding pattern 310 corresponding to the first pattern 201 may be disposed on the first resin layer 232.

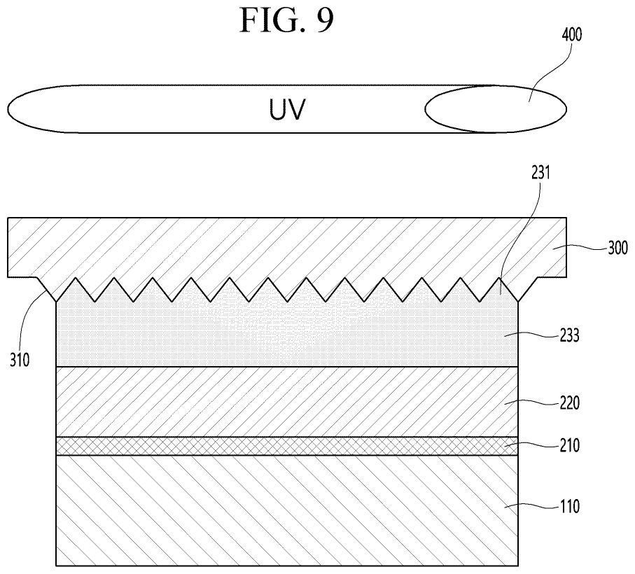

Thereafter, as illustrated in FIG. 9, the first pattern mold 300 may be bonded to the first resin layer 232 (step S140). Accordingly, a first resin layer 233 before curing having a unit shape 231 corresponding to the first pattern may be formed. In this way, the first pattern 201 (see FIG. 2) having the unit shape 231 corresponding to the corresponding pattern 310 of the first pattern mold 300 may be formed on the upper surface of the first resin layer 232.

Next, the first resin layer 232 may be cured (step S150). This curing process may depend on the characteristics of the first resin layer 232. For example, when the first resin layer 232 is an ultraviolet (UV) curing film, ultraviolet UV rays may be irradiated to the first resin layer 232 using a UV lamp 400. As another example, in the case that the first resin layer 232 is a heat-curable film, heat may be applied to the first resin layer 232 to harden it.

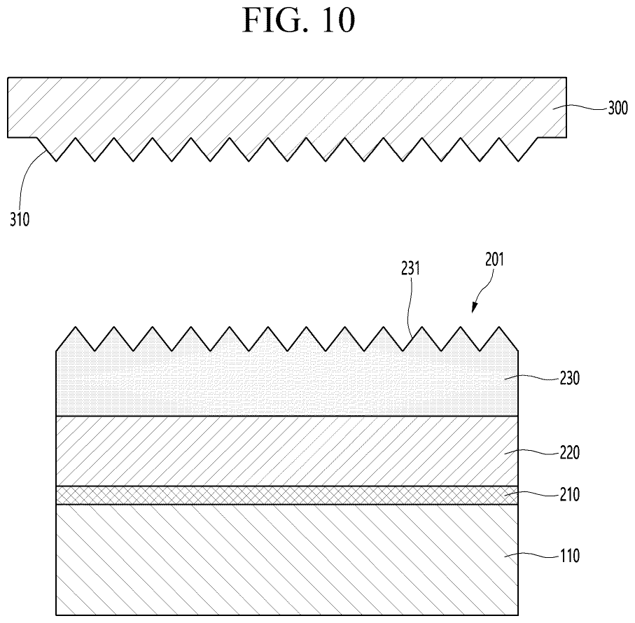

Thereafter, referring to FIG. 10, the first pattern mold 300 may be removed (step S160). Through this process, the first resin layer 230 may be cured by forming the pattern 201 having unit shapes 231 on its surface. During this process, the first pattern 201 may be exposed.

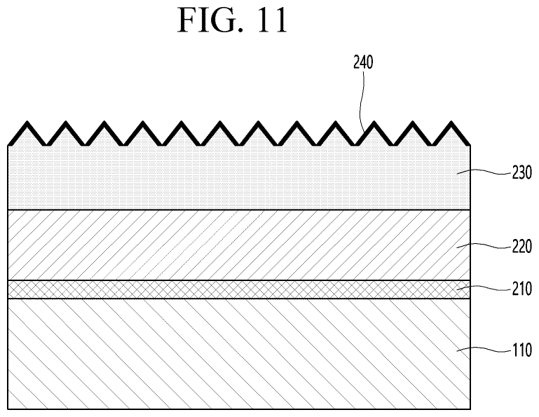

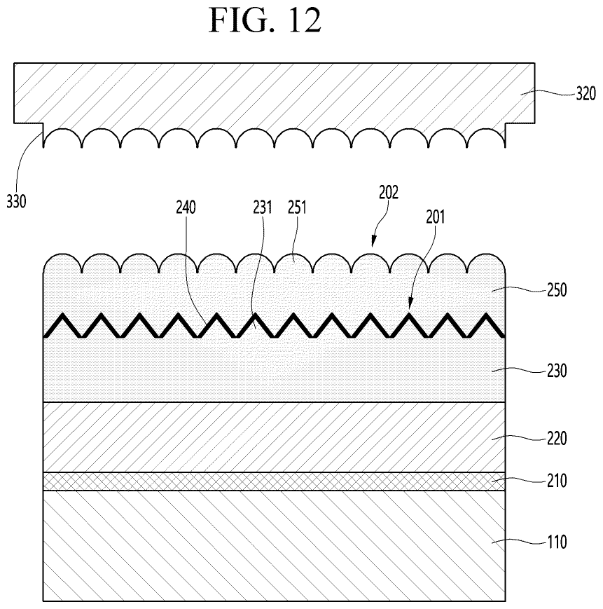

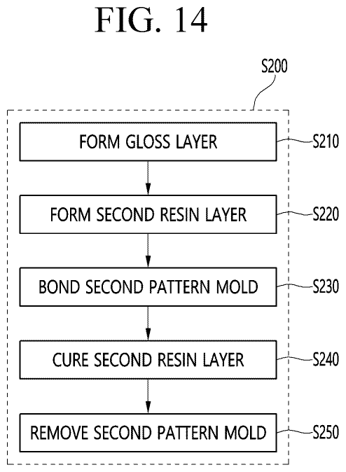

FIGS. 11 and 12 are cross-sectional views illustrating a process for manufacturing an electronic device according to a second embodiment of the present disclosure. FIG. 14 is a flowchart illustrating a process for manufacturing an electronic device according to a second embodiment of the present disclosure.

Hereinafter, a process S200 for manufacturing an electronic device according to a first embodiment of the present disclosure will be described step-by-step with reference to FIGS. 11, 12, and 14. Here, common processes with the first embodiment will be omitted, and subsequent processes will be briefly described.

Referring to FIG. 11, the gloss layer 240 may be formed on the first pattern 201 formed by the process described above (step S210). Since the gloss layer 240 is formed on the first pattern 201, the gloss layer 240 may be formed along the surface of the first pattern 201.

The gloss layer 240 may have a metallic gloss. The gloss layer 240 may include either chromium (Cr) or zirconium (Zr). However, the gloss layer 240 may be formed using various metals, such as silver (Ag), aluminum (Al), titanium (Ti), magnesium (Mg), and gold (Au).

As an exemplary embodiment, the gloss layer 240 may be formed using a PVD (Physical Vapor Deposition) method. However, the gloss layer 240 may also be formed using various methods for forming a metal thin film.

Subsequently, referring to FIG. 12, the second resin layer 250 may be formed on the gloss layer 240 (step S220). Thereafter, the second pattern 202 may be formed on the second resin layer 250. The process of forming this second pattern 202 may be identical to the process of forming the first pattern 201 described above.

For example, the process of forming the second pattern 202 may include a process S230 of bonding a second pattern mold 320 having a second pattern or a corresponding pattern 330 corresponding to the second pattern on the second resin layer 250, a process S240 of curing the second resin layer 250, and a process S250 of removing the second pattern mold 320. Through these processes, the second pattern 202 may be exposed.

In this case, for example, at least one of the first pattern 201 or the second pattern 202 may include at least one of a random pattern, a hairline pattern, an etched pattern, an embossed pattern, a sandblasted pattern, a mirror pattern, or an optical pattern.

According to the embodiments of the present disclosure, various colors may be applied to the color layer 220 to create a variety of colors. In particular, patterns may be created on a white color. Conventionally, spraying is a common method for creating white, but this method has the disadvantage of creating a monotonous feel. To create a metallic feel, aluminum may be used in a laptop computer. In this case, anodizing is typically used as a post-processing method, but this process may not be able to create a white color.

However, according to the embodiments of the present disclosure, white color may be applied while simultaneously providing additional functionality through pattern formation.

Meanwhile, a metallic gloss may be created using the gloss layer, and furthermore, applying an optical pattern may express a three-dimensional feel.

Therefore, according to the embodiments of the present disclosure, the appearance of an electronic device may be enhanced with a three-dimensional pattern including a metallic sheen. In addition, various functions may be provided.

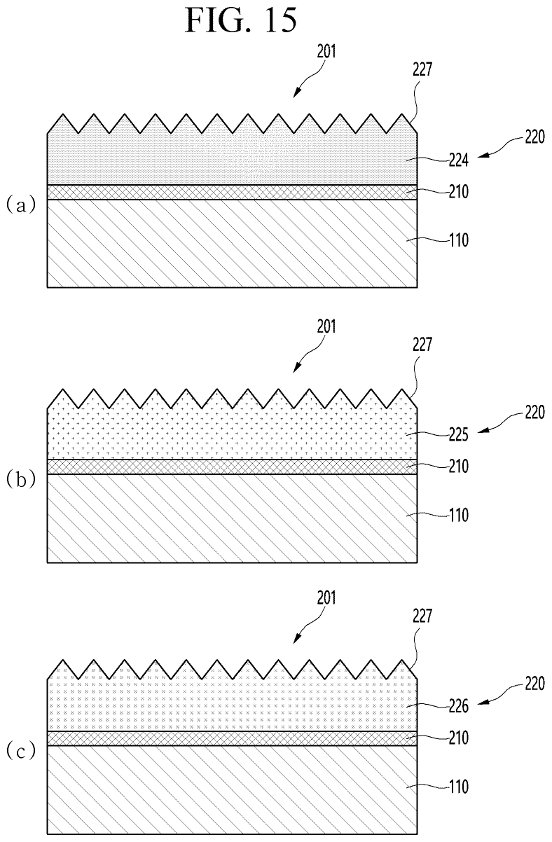

FIG. 15 is a cross-sectional view illustrating a top plate of an electronic device according to a third embodiment of the present disclosure.

Referring to FIG. 15, a state in which the functional layers 210 and 220 are provided on the top plate 110 of the electronic device 10 according to a third embodiment of the present disclosure is schematically illustrated.

Here, the third embodiment of the present disclosure exemplarily illustrates a state in which the functional layers 210 and 220 are provided on the top plate 110 of the electronic device 10. Therefore, the top plate 110 of the electronic device 10 may be referred to as a base layer. That is, the functional layers 210 and 220 may be implemented by combining with the base layers of various products. For example, the base layer including these functional layers 210 and 220 may be referred to as a plate-shaped substrate.

Hereinafter, the top plate 110 and the base layer 110 will be described using the same reference numeral.

For example, the base layer 110 may include a metal substrate. For example, the base layer 110 may include aluminum (Al) or magnesium (Mg). For example, the base layer 110 may be formed of aluminum (Al) or magnesium (Mg).

Referring to FIG. 15, the color layer 220 may be disposed on the top plate 110 (base layer). For example, a chemical treatment may be performed to prevent corrosion and/or improve adhesion of the base layer 110. Accordingly, the chemical layer or primer 210 formed as a result of the chemical treatment may be provided between the base layer 110 and the color layer 220.

The color layer 220 including the first layer having the first color may be disposed on the ignition layer or primer 210. For example, the color layer 220 may be formed as the first layer having the first color.

The color layer 220 may impart a color to the base layer 110. For example, white, gray, black, or other colors may be imparted to the base layer 110.

FIG. 15A a illustrates a state in which a first color layer 224 having a first color is provided. FIG. 15B illustrates a state in which a second color layer 225 having a first color is provided. FIG. 15C illustrates a state in which a third color layer 226 having a first color is provided. Meanwhile, the color layer 220 may include the particles 223 (see FIG. 3) for expressing color.

When the character or pattern 130 (see FIG. 1) such as the brand, manufacturer, or logo of the electronic device 10 are displayed, the character or pattern 130 may be displayed using the color layer 220.

Such color layers 220; 224, 225, and 226 may be implemented as resin layers. As described above, various materials that may be cured through post-processing may be used for these resin layers. For example, in addition to resin, various materials that may be cured by heat or light ultraviolet rays may be used.

The color layer 220 (colored resin layer) implemented as such a resin layer may include the pattern 201 having unit shapes 227. The pattern 201 may include at least one of a random pattern, a hairline pattern, an etched pattern, an embossed pattern, a sandblasted pattern, a mirror pattern, or an optical pattern.

By this pattern 201, the reflected light R from the incident light A is diffusely reflected at various angles, so that the color layer 220; 224, 225, and 226 (colored resin layer) having the pattern 201 may improve the appearance. Meanwhile, as described above, the color layer 220 having the pattern 201 may improve the appearance of the electronic device 10 including the base layer 110. For example, the color layer 220 having the pattern 201 may improve the emotional qualities such as touch, grip, and grip. For example, the resin layer 230 having the pattern 201 may prevent damage such as corrosion of the top plate 110 and contamination such as fingerprint marks.

For example, the surface of an electronic device such as a laptop computer may be made of stainless steel (SUS). In this case, the surface may be processed to form various patterns to prevent surface corrosion and fingerprint marks.

To form a pattern on such stainless steel, a brush or sandpaper may be used. Furthermore, the process of forming a pattern on such stainless steel may be applied to materials such as aluminum. When using aluminum, this process involves post-processing such as anodizing. Requires. However, during this post-processing process, the visibility of the pattern may deteriorate, or the product logo or brand shape may become blurred. In other words, during the process of applying post-processing, the visibility of the pattern formed on the surface of the metal base layer may deteriorate, and differences in shape may occur from the initially formed pattern.

However, according to the above-described embodiments of the present disclosure, the desired pattern shape may be expressed without change, and this pattern may be applied to multiple electronic devices to produce them with consistent quality. Thus, according to the embodiments of the present disclosure, the reproducibility and stability of pattern formation, as well as productivity, may be improved.

According to the present embodiment, by utilizing the color layer 220; 224, 225, and 226 (colored resin layer) formed with a resin layer having the pattern 201 having the unit shapes 227, the stacking structure of the functional layer may be simplified, thereby reducing the manufacturing steps and manufacturing costs.

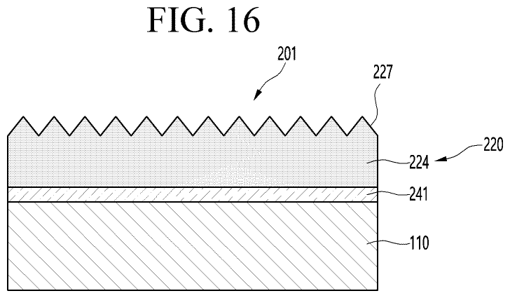

FIG. 16 is a cross-sectional view illustrating a top plate of an electronic device according to a fourth embodiment of the present disclosure.

Referring to FIG. 16, a state in which functional layers 210, 241 and 220 are provided on the top plate 110 of the electronic device 10 according to a fourth embodiment of the present disclosure is schematically illustrated.

The base layer 110 may include a metal substrate. For example, the base layer 110 may include aluminum (Al) or magnesium (Mg). For example, the base layer 110 may be formed of aluminum (Al) or magnesium (Mg).

The base layer 110 including such a metal substrate may include a polishing layer 241 having a mirror finish. For example, the surface of the base layer 110 may be mirror-polished to form the polishing layer 241. The polishing layer 241 has a metallic luster, and thus, an appearance with a metallic luster may be expressed.

The color layer 220 (224; colored resin layer) implemented as a resin layer having the pattern 201 having the unit shapes 227 may be disposed on this polishing layer 241. The color layer 224 may be the same as that of the third embodiment described above. Therefore, a redundant description will be omitted.

The electronic device according to the third and fourth embodiments described above may include a simplified manufacturing process compared to the other embodiments described above.

For example, in the manufacturing process of the electronic device according to the third and fourth embodiments, the process S130 of forming the first resin layer 232 on the color layer 220 in the manufacturing step described above with reference to FIG. 13 may be omitted. That is, the color layer 220 (224, 225, and 226; colored resin layer) may be formed with the colored resin layer, and the first pattern 201 may be formed on the color layer 220. In some cases, the color layer 220 (224, 225, and 226) may be formed through a process of forming a resin layer and imparting color to the resin layer.

The manufacturing process of the electronic device according to the third and fourth embodiments may include, with reference to FIG. 13, a step of surface-treating the base layer 110 (step S110), a step of forming the colored resin layer 224, 225, and 226 with a color imparted to the resin layer on the base layer 110 (step S130), a step of bonding the first pattern mold 300 having the first pattern on the colored resin layer 224, 225, and 226 (step S140), a step of curing the colored resin layer 224, 225, and 226 (step S150), and a step of removing the first pattern mold 300 to expose the first pattern 201 (step S160).

Meanwhile, the manufacturing process of the electronic device according to the third and fourth embodiments may further include a process of mirror-polishing grinding the surface of the metal when the base layer 110 includes metal. For example, the manufacturing process of the electronic device according to the fourth embodiment may further include a process of polishing grinding the surface of the metal forming the base layer 110 to form the polishing layer 241.

Other than that, the details and manufacturing process described above with reference to the first and second embodiments may be applied in the same manner as described above.

The electronic device described above is not limited to the configurations and methods of the described embodiments, and the embodiments may be configured by selectively combining all or some of the embodiments so that various modifications may be made.

The above description merely exemplifies the technical concepts of the present disclosure. Those skilled in the art will appreciate that various modifications and variations may be made without departing from the essential characteristics of the present disclosure.

Therefore, the embodiments disclosed in this disclosure are intended to illustrate, rather than limit, the technical concepts of the present disclosure, and the scope of the technical concepts of the present disclosure is not limited by these embodiments.

The scope of protection of the present disclosure should be interpreted by the following claims, and all technical concepts within a scope equivalent thereto should be interpreted as being included within the scope of the rights of the present disclosure.

What is claimed is:

1. An electronic device comprising:
a base layer;
a color layer comprising a first layer disposed on the base layer and having a first color;
a first resin layer disposed on the color layer and having a first pattern;
a second resin layer disposed on the first resin layer and having a second pattern; and
a gloss layer disposed between the first resin layer and the second resin layer, which imparts gloss to the color layer.

2. The electronic device of claim 1, wherein the base layer includes aluminum or magnesium.

3. The electronic device of claim 1, wherein the color layer further includes a second layer having a second color.

4. The electronic device of claim 1, wherein the color layer further includes metal or metal oxide particles.

5. The electronic device of claim 1, wherein the gloss layer has a metallic gloss.

6. The electronic device of claim 1, wherein at least one of the first pattern and the second pattern includes at least one of a random pattern, a hairline pattern, an etched pattern, an embossed pattern, a sandblasted pattern, a mirror pattern, or an optical pattern.

7. A method for manufacturing an electronic device having a plate-shaped layer, the method comprising:
surface-treating a base layer;
forming a color layer on the base layer;
forming a first resin layer on the color layer;
adhering a first pattern mold having a first pattern on the first resin layer;
curing the first resin layer; and
removing the first pattern mold to expose the first pattern.

8. The method of claim 7, wherein the base layer includes aluminum or magnesium.

9. The method of claim 7, wherein surface-treating the base layer includes:
performing a chemical treatment on a surface of the base layer or coating the surface of the base layer with a primer.

10. The method of claim 7, wherein forming the color layer includes:
forming a first layer having a first color; and
forming a second layer having a second color on the first layer.

11. The method of claim 7, wherein forming the color layer includes:
applying metal or metal oxide particles.

12. The method of claim 7, further comprising:
forming a gloss layer on the first pattern.

13. The method of claim 12, wherein the gloss layer includes at least one of chromium (Cr) or zirconium (Zr).

14. The method of claim 12, further comprising:
forming a second resin layer on the gloss layer;
bonding a second pattern mold having a second pattern on the second resin layer;
curing the second resin layer; and
removing the second pattern mold to expose the second pattern.

15. The method of claim 7, wherein at least one of the first pattern and the second pattern includes at least one of a random pattern, a hairline pattern, an etched pattern, an embossed pattern, a sandblasted pattern, a mirror pattern, or an optical pattern.

16. A method for manufacturing an electronic device having a plate-shaped layer, comprising:
surface-treating a base layer;
forming a colored resin layer on the base layer, to which a color is provided to a resin layer;
bonding a first pattern mold having a first pattern on the colored resin layer;
curing the colored resin layer; and
removing the first pattern mold to expose the first pattern.

17. The method of claim 16, wherein the base layer includes metal, and further comprising polishing a surface of the metal.

18. The method of claim 16, wherein the base layer includes aluminum or magnesium.

19. The method of claim 16, wherein surface-treating the base layer includes:
performing a chemical treatment on a surface of the base layer or coating the surface of the base layer with a primer.

20. The method of claim 16, wherein the first pattern includes at least one of a random pattern, a hairline pattern, an etched pattern, an embossed pattern, a sandblasted pattern, a mirror pattern, or an optical pattern.
